(19) United States
(12) Patent Application Publication
(10) Pub. No.: US 2025/0389570 A1
(43) Pub. Date: Dec. 25, 2025

(54) PROPANE TANK MONITORING SYSTEM

(71) Applicant: Geoffrey Evertz, Buffalo, NY (US)

(72) Inventor: Geoffrey Evertz, Buffalo, NY (US)

(21) Appl. No.: 18/103,724

(22) Filed: Jan. 31, 2023

(51) Int. Cl. G01F 23/20; G08B 21/18; H02J 7/00

(52) U.S. Cl. CPC G01F 23/20; G08B 21/182; H02J 7/0048

(57) ABSTRACT

The propane tank monitoring system may include a tank cradle, a controller, and a plurality of load cells. The tank cradle may retain a propane tank while the propane tank is in use. The plurality of load cells may determine a tank weight for the propane tank. The controller may estimate a fill level of the propane tank based upon the tank weight. When the fill level falls below a predetermined fuel threshold, the controller may notify one or more entities using a communication circuit. As non-limiting examples, the one or more entities may include a user and/or a propane tank exchange service, which may send personnel to exchange the propane tank.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of fuel tank monitoring systems, more specifically, a propane tank monitoring system.

### SUMMARY OF INVENTION

The propane tank monitoring system may comprise a tank cradle, a controller, and a plurality of load cells. The tank cradle may retain a propane tank while the propane tank is in use. The plurality of load cells may determine a tank weight for the propane tank. The controller may estimate a fill level of the propane tank based upon the tank weight. When the fill level falls below a predetermined fuel threshold, the controller may notify one or more entities using a communication circuit. As non-limiting examples, the one or more entities may comprise a user and/or a propane tank exchange service, which may send personnel to exchange the propane tank.

An object of the invention is to weigh a propane tank while the propane tank is in use and for a controller to estimate a fill level of the propane tank based upon the tank weight.

Another object of the invention is to communicate via a communication circuit with one or more entities is the fill level of the propane tank is determined to fall below a predetermined fuel threshold.

A further object of the invention is to provide a plurality of user interface devices such that a user may monitor the fill level of the tank and the battery charge level and may enable and disable the communication circuit.

Yet another object of the invention is to recharge one or more batteries that power the invention via one or more solar panels, one or more wireless power receivers, or both.

These together with additional objects, features and advantages of the propane tank monitoring system will be readily apparent to those of ordinary skill in the art upon reading the following detailed description of the presently preferred, but nonetheless illustrative, embodiments when taken in conjunction with the accompanying drawings.

In this respect, before explaining the current embodiments of the propane tank monitoring system in detail, it is to be understood that the propane tank monitoring system is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the propane tank monitoring system.

It is therefore important that the claims be regarded as including such equivalent construction insofar as they do not depart from the spirit and scope of the propane tank monitoring system. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is an isometric view of an embodiment of the disclosure.

FIG. 2 is a front view of an embodiment of the disclosure.

FIG. 3 is a side view of an embodiment of the disclosure.

FIG. 4 is a top view of an embodiment of the disclosure.

FIG. 5 is an exploded view of an embodiment of the disclosure.

FIG. 6 is an in-use view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description. As used herein, the word “or” is intended to be inclusive.

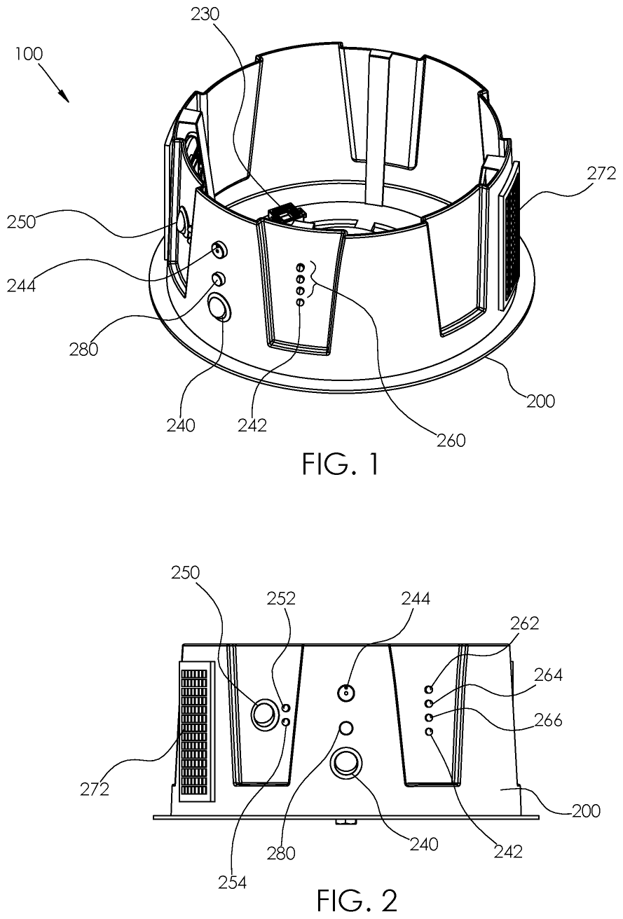

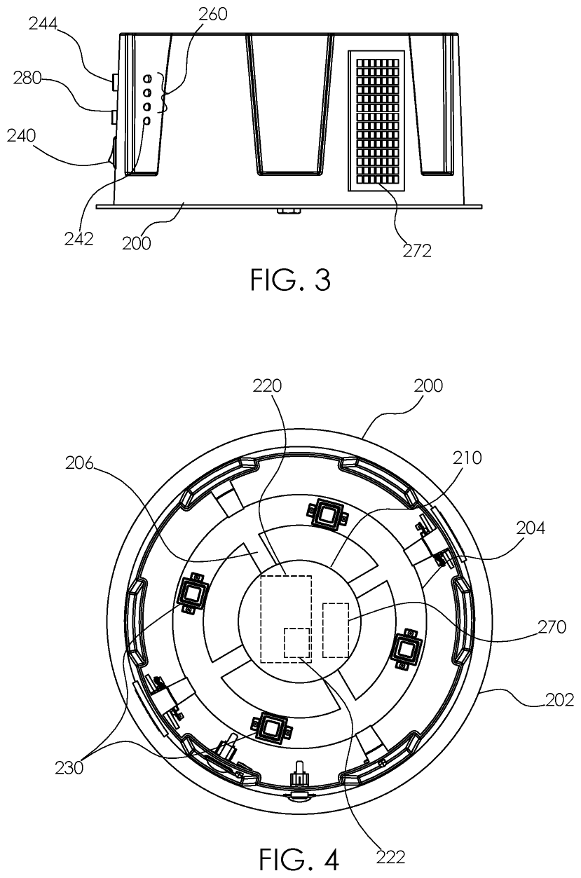

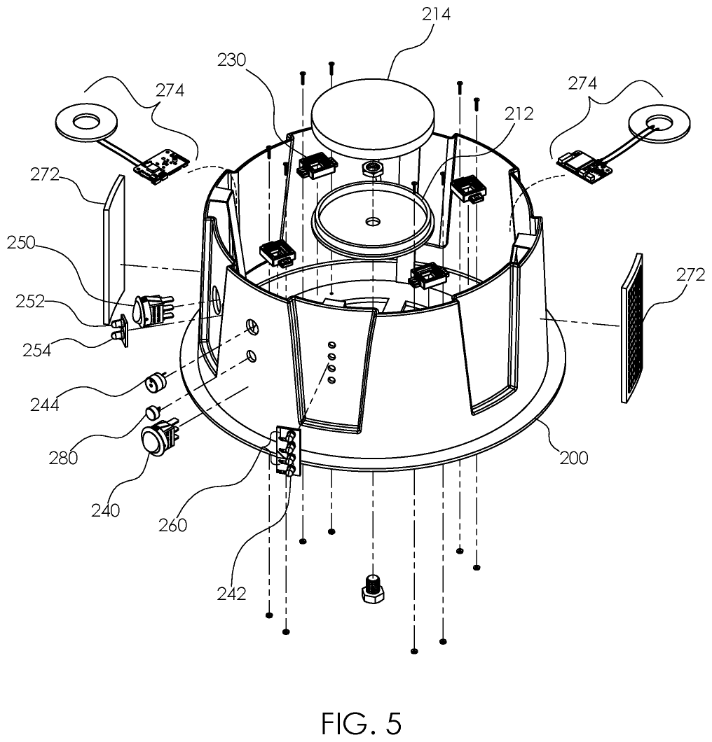

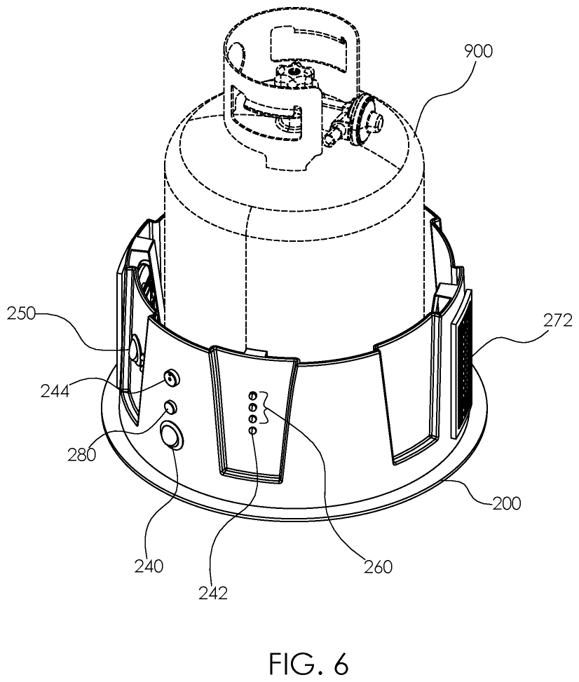

Detailed reference will now be made to a first potential embodiment of the disclosure, which is illustrated in FIGS. 1 through 6.

The propane tank monitoring system 100 (hereinafter invention) comprises a tank cradle 200, a controller 220, and a plurality of load cells 230. The tank cradle 200 may retain a propane tank 900 while the propane tank 900 is in use. The plurality of load cells 230 may determine a tank weight for the propane tank 900. The controller 220 may estimate a fill level of the propane tank 900 based upon the tank weight. When the fill level falls below a predetermined fuel threshold, the controller 220 may notify one or more entities using a communication circuit 222. As non-limiting examples, the one or more entities may comprise a user and/or a propane tank exchange service, which may send personnel to exchange the propane tank 900.

The tank cradle 200 may hold the propane tank 900 in an upright orientation. The tank cradle 200 may comprise an outer wall 202 that defines a well for the bottom of the propane tank 900 to slide into. The tank cradle 200 may comprise an inner ring 204 that may be coupled to the outer wall 202 by radial armatures 206. The inner ring 204 and the radial armatures 206 may define a bottom of the well.

A circuit housing 210 may be coupled to the radial armatures 206 at the center of the tank cradle 200. The circuit housing 210 may house the controller 220. The circuit housing 210 may comprise a housing base 212 and a housing cover 214. The housing cover 214 may be removeable such that the controller 220 may be accessed.

The controller 220 may comprise a microprocessor and memory wherein the memory may contain instructions for causing the microprocess to control the sequence and timing of the invention 100. As non-limiting examples, the controller 220 may acquire the tank weight from the plurality of load cells 230, may convert the tank weight into the fill level, may initiate communications, may monitor a charge level of one or more batteries 270, and may be adapted to interact with the user via a plurality of user interface devices.

The communication circuit 222 may be operable to support a two-way communication channel between the controller 220 and an external device. As non-limiting examples, the external device may be a smartphone or a computer. The communication circuit 222 may comprise a WiFi transceiver and a cell phone transceiver. In some embodiments, the cell phone transceiver may support the GSM standard. The WiFi transceiver may support IEEE 802.11 protocols.

The bottom of the propane tank 900 may rest on the plurality of load cells 230 when the propane tank 900 is placed into the tank cradle 200. Each of the plurality of load cells 230 may be a force transducer that may measure an applied force and generate an electrical signal that may be representative of the applied force. The electrical signals from all of the plurality of load cells 230 may be routed to the controller 220 where the controller 220 may convert the electrical signals into an estimate of the tank weight. In a preferred embodiment, that may be four load cells.

The plurality of user interface devices may be accessible on the outside of the outer wall 202 of the tank cradle 200. The plurality of user interface devices may be adapted to inform the user of the state of the invention 100 and the propane tank 900 and may be adapted for the user to control operation of the invention 100.

The plurality of user interface devices may comprise an ON/OFF control 240. The ON/OFF control 240 may be operable to apply and remove power to the invention 100.

The plurality of user interface devices may comprise a battery low indicator 242. The battery low indicator 242 may be energized by the controller 220 when the charge level of the one or more batteries 270 is determined to have fallen below a predetermined battery charge threshold.

The plurality of user interface devices may comprise a buzzer 244. The buzzer 244 may be adapted to be energized by the controller 220 in order to notify the user of an alert condition. As non-limiting examples, the alert condition may comprise that the fill level that has fallen below the predetermined fuel threshold, that the charge level that has fallen below the predetermined battery charge threshold, that communication has failed, or any combination thereof.

The plurality of user interface devices may comprise a communications selector control 250. The communications selector control 250 may comprise a 3-way switch that selects between no communication, WiFi communication, and cell phone communication. Responsive to selecting WiFi communication and verifying a WiFi link, the controller 220 may illuminate a WiFi indicator 252. Responsive to selecting cell phone communication and verifying access to a cell phone network, the controller 220 may illuminate a cellphone indicator 254.

The plurality of user interface devices may comprise a fuel level display 260. The fuel level display 260 may be activated by the controller 220 to show the fill level within the propane tank 900. In a preferred embodiment, the fuel level display 260 may comprise three LEDs having different colors to represent the state of the fill level. A green LED 262 may be illuminated to indicate that the fill level is above the predetermined fuel threshold and is therefore nominal. A yellow LED 264 may be illuminated to indicate that the fill level has fallen below the predetermined fuel threshold and is therefore low. A red LED 266 may be illuminated to indicate that the propane tank 900 has been determined to be empty. In some embodiments, the fuel level display 260 may comprise blinking states. As non-limiting examples, the yellow LED 264 may blink in the lower half of the low fuel range and the red LED 266 may blink when illuminated.

The one or more batteries 270 may comprise one or more energy-storage devices. The one or more batteries 270 may be a source of electrical energy to operate the controller 220, the plurality of load cells 230, the communication circuit 222, and the plurality of user interface devices. The one or more batteries 270 may be rechargeable and/or replaceable.

In some embodiments, the one or more batteries 270 may be recharged from one or more solar panel 272 located on the outside of the tank cradle 200. In some embodiments, the one or more batteries 270 may be recharged from one or more wireless power receivers 274 located within the tank cradle 200. The one or more wireless power receivers 274 may receive power inductively from one or more wireless power transmitters that are external to the invention 100.

In some embodiments, the invention 100 may comprise a microphone 280 that is accessible on the outside of the tank cradle 200. The microphone 280 may be adapted to convert sounds local to the propane tank 900 into an audio signal that may be routed to the controller 220 such that the controller 220 may pass audio to the external device and/or to accept voice commands directed to the controller 220.

In use, the propane tank 900 may be placed into the tank cradle 200 and the propane tank 900 may be used to fuel a propane appliance. As non-limiting examples, the propane appliance may be a grill, a griddle, a patio heater, or a fire pit. The plurality of load cells 230 within the tank cradle 200 may weigh the propane tank 900 and may provide the controller 220 with the tank weight such that the controller 220 may estimate the fill level.

The controller 220 may display the fill level via the fuel level display 260 to indicate whether the fill level is nominal, low, or empty. When the fill level falls below the predetermined fuel threshold, the controller 220 may initiate communication via the communication circuit 222 to report the fill level to the user, to a propane tank exchange service, or both. Responsive to notification of a low fuel level, the propane tank exchange service may send personnel to replace the propane tank 900.

### DEFINITIONS

Unless otherwise stated, the words “up”, “down”, “top”, “bottom”, “upper”, and “lower” should be interpreted within a gravitational framework. “Down” is the direction that gravity would pull an object. “Up” is the opposite of “down”. “Bottom” is the part of an object that is down farther than any other part of the object. “Top” is the part of an object that is up farther than any other part of the object. “Upper” may refer to top and “lower” may refer to the bottom. As a non-limiting example, the upper end of a vertical shaft is the top end of the vertical shaft.

Throughout this document the terms “battery”, “battery pack”, and “batteries” may be used interchangeably to refer to one or more wet or dry cells or batteries of cells in which chemical energy is converted into electricity and used as a source of DC power. References to recharging or replacing batteries may refer to recharging or replacing individual cells, individual batteries of cells, or a package of multiple battery cells as is appropriate for any given battery technology that may be used. The battery may require electrical contacts which may not be illustrated in the figures.

As used in this disclosure, a “buzzer” may be two lead electrical device that generates an audible sound when voltage is applied to the two leads.

As used herein, “cellular network” or “cell phone network” may refer to a communication network where the link to and from end nodes is wireless. The network may be distributed over land areas called cells, each served by at least one fixed-location transceiver. As non-limiting examples, the wireless protocols used to communicate with end nodes may comprise CDMA, GSM, and LTE.

As used herein, the words “control” or “controls” are intended to include any device which can cause the completion or interruption of an electrical circuit; non-limiting examples of controls include toggle switches, rocker switches, push button switches, rotary switches, electromechanical relays, solid state relays, touch sensitive interfaces and combinations thereof whether they are normally open, normally closed, momentary contact, latching contact, single pole, multi-pole, single throw, or multi-throw. In some embodiments, a control may alter an electrical property of a circuit such as resistance, inductance, or capacitance.

As used herein, the words “couple”, “couples”, “coupled” or “coupling”, may refer to connecting, either directly or indirectly, and does not necessarily imply a mechanical connection.

As used herein, “GSM” may refer ‘Global System for Mobile communication’, a standard for mobile phone communication.

As used in this disclosure, a “housing” may be a rigid or semi-rigid casing that encloses and protects one or more devices.

As used in this disclosure, an “LED” may be an acronym for a light emitting diode. An LED allows current to flow in one direction and when current is flowing the LED emits photons. The wavelength of the light that is emitted may be in the visible range of the spectrum or may extend into either the infrared (IR) spectral range or the ultraviolet (UV) spectral range. The brightness of the LED can be increased and decreased by controlling the amount of current flowing through the LED. Multiple LEDs having different emission spectrums may be packaged into a single device to produce a multi-color LED. A broad range of colors may be produced by multi-color LEDs by selecting which of the multiple LEDs are energized and by controlling the brightness of each of the multiple LEDs. Organic LEDs (OLEDs) are included in this definition.

As used in herein, a “load cell” may be a force transducer that may measure an applied force and generate an electrical signal that is representative of the applied force. The applied force may be in the form of tension, compression, pressure, or torque. As a non-limiting example, a load cell may be a strain gauge.

As used in this disclosure, a “microphone” may be a transducer that converts the energy from vibration into electrical energy. The sources of vibrations include, but are not limited to, acoustic energy.

As used in this disclosure, “orientation” may refer to the positioning and/or angular alignment of a first object relative to a second object or relative to a reference position or reference direction.

As used herein, the terms “processor”, “central processor”, “central processing unit”, “CPU”, or “microprocessor” may refer to a digital device that carries out the instructions comprising a computer program by performing basic arithmetic, logical, control, and input/out operations. The term “microprocessor” may additionally imply a level of miniaturization and power reduction that makes the device suitable for portable or battery operated systems.

As used in this disclosure, the term “radial” may refer to a direction which is perpendicular to an identified central axis or which projects away from a center point.

As used herein, “smart phone” or “smartphone” may refer to a personal communication device that incorporates cellular phone calling and texting capabilities along with advanced features. Non-limiting examples of the advanced features of a smart phone may include camera functions, multimedia functions (such as music and video recording and playback and gaming), internet functions (such as web browsing and file uploading/downloading), and Global Positioning System capabilities. A smartphone may be able to execute downloaded application programs that expand the capabilities of the smartphone.

As used herein, “solar panel” may refer to an assembly of solar cells that are electrically wired in series and/or in parallel in order to produce a usable DC output.

As used in this disclosure, a “switch” may be an electrical device that starts and stops the flow of electricity through an electric circuit by completing or interrupting an electric circuit. The act of completing or interrupting the electrical circuit may be called actuation. Completing or interrupting an electric circuit with a switch is often referred to as closing or opening a switch, respectively. Completing or interrupting an electric circuit is also referred to as making or breaking the circuit, respectively.

As used in this disclosure, a “transceiver” may be a device that is used to transmit and/or receive signals. The signals may be audible, optical, or RF in nature.

As used in this disclosure, a “transducer” may be a device that converts a physical quantity, such as pressure or brightness into an electrical signal or a device that converts an electrical signal into a physical quantity.

As used in this disclosure, “WiFi” may refer to the physical implementation of one or more of a collection of wireless electronic communication standards commonly referred to as IEEE 802.11x and used for wireless communication between devices.

As used in this disclosure, “wireless” may be an adjective that is used to describe a communication channel that does not require the use of physical cabling.

With respect to the above description, it is to be realized that the optimum dimensional relationship for the various components of the invention described above and in FIGS. 1 through 6, include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

The inventor claims:

1. A propane tank monitoring system comprising:
a tank cradle, a controller, and a plurality of load cells;
wherein the tank cradle retains a propane tank while the propane tank is in use;
wherein the plurality of load cells determine a tank weight for the propane tank;
wherein the controller estimates a fill level of the propane tank based upon the tank weight;
wherein when the fill level falls below a predetermined fuel threshold, the controller notifies one or more entities using a communication circuit;
wherein the tank cradle holds the propane tank in an upright orientation;
wherein the tank cradle comprises an outer wall that defines a well for a bottom of the propane tank to slide into;
wherein the controller acquires the tank weight from the plurality of load cells, converts the tank weight into the fill level, initiates communications, monitors a charge level of one or more batteries, and is adapted to interact with a user via a plurality of user interface devices.

2. The propane tank monitoring system according to claim 1
wherein the tank cradle comprises an inner ring that is coupled to the outer wall by radial armatures;
wherein the inner ring and the radial armatures define a bottom of the well.

3. The propane tank monitoring system according to claim 2
wherein a circuit housing is coupled to the radial armatures at the center of the tank cradle;
wherein the circuit housing houses the controller;
wherein the circuit housing comprises a housing base and a housing cover;
wherein the housing cover is removeable such that the controller is accessible.

4. The propane tank monitoring system according to claim 3
wherein the controller comprises a microprocessor and memory.

5. (canceled)

6. The propane tank monitoring system according to claim 4
wherein the communication circuit is operable to support a two-way communication channel between the controller and an external device;
wherein the communication circuit comprises a WiFi transceiver and a cell phone transceiver.

7. The propane tank monitoring system according to claim 6
wherein the cell phone transceiver supports the GSM standard;
wherein the WiFi transceiver supports IEEE 802.11 protocols.

8. The propane tank monitoring system according to claim 6
wherein the bottom of the propane tank rests on the plurality of load cells when the propane tank is placed into the tank cradle;
wherein each of the plurality of load cells is a force transducer that measures an applied force and generates an electrical signal that is representative of the applied force;
wherein the electrical signals from all of the plurality of load cells are routed to the controller where the controller converts the electrical signals into an estimate of the tank weight.

9. The propane tank monitoring system according to claim 8
wherein the plurality of user interface devices are accessible on the outside of the outer wall of the tank cradle;
wherein the plurality of user interface devices are adapted to inform the user of the state of the propane tank monitoring system and the propane tank and are adapted for the user to control operation of the propane tank monitoring system.

10. The propane tank monitoring system according to claim 9
wherein the plurality of user interface devices comprise an ON/OFF control;
wherein the ON/OFF control is operable to apply and remove power to the propane tank monitoring system;
wherein the plurality of user interface devices comprise a battery low indicator;
wherein the battery low indicator is energized by the controller when the charge level of the one or more batteries is determined to have fallen below a predetermined battery charge threshold;
wherein the plurality of user interface devices comprise a buzzer;
wherein the buzzer is adapted to be energized by the controller in order to notify the user of an alert condition.

11. The propane tank monitoring system according to claim 10
wherein the plurality of user interface devices comprise a communications selector control;
wherein the communications selector control comprises a 3-way switch that selects between no communication, WiFi communication, and cell phone communication;
wherein responsive to selecting WiFi communication and verifying a WiFi link, the controller illuminates a WiFi indicator;
wherein responsive to selecting cell phone communication and verifying access to a cell phone network, the controller illuminates a cellphone indicator.

12. The propane tank monitoring system according to claim 11
wherein the plurality of user interface devices comprise a fuel level display;
wherein the fuel level display is activated by the controller to show the fill level within the propane tank.

13. The propane tank monitoring system according to claim 12
wherein the fuel level display comprises three LEDs having different colors to represent the state of the fill level;
wherein a green LED is illuminated to indicate that the fill level is above the predetermined fuel threshold and is therefore nominal;
wherein a yellow LED is illuminated to indicate that the fill level has fallen below the predetermined fuel threshold and is therefore low;
wherein a red LED is illuminated to indicate that the propane tank has been determined to be empty;
wherein the fuel level display comprises blinking states.

14. The propane tank monitoring system according to claim 13
wherein the one or more batteries comprise one or more energy-storage devices;
wherein the one or more batteries are a source of electrical energy to operate the controller, the plurality of load cells, the communication circuit, and the plurality of user interface devices;
wherein the one or more batteries are rechargeable and/or replaceable.

15. The propane tank monitoring system according to claim 14
wherein the one or more batteries are recharged from one or more solar panel located on the outside of the tank cradle.

16. The propane tank monitoring system according to claim 14
wherein the one or more batteries are recharged from one or more wireless power receivers located within the tank cradle.

17. The propane tank monitoring system according to claim 14
wherein the propane tank monitoring system comprises a microphone that is accessible on the outside of the tank cradle;
wherein the microphone is adapted to convert sounds local to the propane tank into an audio signal that is routed to the controller such that the controller passes audio to the external device and/or to accept voice commands directed to the controller.

18. A propane tank monitoring system that retains a propane tank while the propane tank is in use;
wherein the propane tank monitoring system determines a tank weight for the propane tank;
wherein when a fill level of the propane tank falls below a predetermined fuel threshold, the propane tank monitoring system notifies one or more entities;
a tank cradle, a controller, and a plurality of load cells;
wherein the controller estimates the fill level of the propane tank based upon the tank weight;
wherein the tank cradle holds the propane tank in an upright orientation;
wherein the tank cradle comprises an outer wall that defines a well for a bottom of the propane tank to slide into;
wherein the tank cradle comprises an inner ring that is coupled to the outer wall by radial armatures;
wherein the inner ring and the radial armatures define a bottom of the well;
wherein the controller acquires the tank weight from the plurality of load cells, converts the tank weight into the fill level, initiates communications, monitors a charge level of one or more batteries, and is adapted to interact with a user via a plurality of user interface devices.

19. (canceled)

20. The propane tank monitoring system according to claim 18
wherein a circuit housing is coupled to the radial armatures at the center of the tank cradle;
wherein the circuit housing houses the controller;
wherein the circuit housing comprises a housing base and a housing cover.
